(19) United States
(12) Patent Application Publication
(10) Pub. No.: US 2020/0320795 A1
(43) Pub. Date: Oct. 8, 2020

(54) SYSTEM AND LAYERING METHOD FOR FAST INPUT-DRIVEN COMPOSITION AND LIVE-GENERATION OF MIXED DIGITAL CONTENT

(71) Applicants: Tammuz Dubnov, La Jolla, CA (US); Shlomo Dubnov, La Jolla, CA (US)

(72) Inventors: Tammuz Dubnov, La Jolla, CA (US); Shlomo Dubnov, La Jolla, CA (US)

(21) Appl. No.: 16/843,852

(22) Filed: Apr. 8, 2020

Related U.S. Application Data
(60) Provisional application No. 62/831,116, filed on Apr. 8, 2019.

(51) Int. Cl. G06T 19/00; G06T 19/20; H04N 13/388

(52) U.S. Cl. CPC G06T 19/006; H04N 13/388; G06T 19/20

(57) ABSTRACT

A system and method for the generation of interactive content by combining, blending, layering, mixing, generating or any combination thereof, of multiple digital contents, where the generated contents are controlled by interaction with viewers via live signals from sensors or by detecting and interacting with viewer mobile computing devices or any combination of user signals and additional information derived from signals to generate the control.

### CROSS-REFERENCE TO RELATED APPLICATIONS

This application claims the benefit of U.S. Provisional Application No. 62/831,116, filed Apr. 8, 2019, and entitled “SYSTEM AND LAYERING METHOD FOR FAST INPUT-DRIVEN COMPOSITION AND LIVE-GENERATION OF MIXED DIGITAL CONTENT”, the entirety of which is hereby incorporated by reference herein.

### TECHNICAL FIELD

The present invention relates systems and methods for creating an augmented reality experience for a user without the need for wearing assisting devices such as virtual reality headset or special computer glass eyewear.

### BACKGROUND

The field of mixed or augmented reality is becoming increasingly applicable to advertising, such as digital signage and information kiosks, and entertainment or information experiences for users, defined herein as persons who experience the augmented reality. These applications can use special lighting and projection design effects, where the displayed content provides enhanced user experience by interacting and altering digital content in response to signals measured from the user and the environment. Such signals may include, without limitation, signals that represent a user position in space, movement, body pose, gestures, perceived age and gender of the user, sounds generated by the user and sounds coming from the environment, general lighting conditions, number of participating users, length of participation, user attributes derived from other signals such as demographics, emotions, and more.

As digital displays become increasingly ubiquitous in most aspects of everyday life, with the primary objective being the transmission and communication of digital content to the viewers, two major challenges exist in the deployment of displays surrounding the content to be displayed. First, there are a growing number of different display types and methods, whether they be televisions, projectors, tablets, LED walls, or any other display type, but all of which require content to display. Further, there are inherent difficulties in content management, whether for a single display or a network of displays, and content management is usually labor-intensive.

In the modern age, there is an abundance of digital content, with more music and videos published than any one person could consume in a lifetime, yet the need for customized and personalized content is only growing. As audiences evolve their expectations grow to expect many institutions to have their own unique and branded content to display on their screens. The several limiting factors in such a world are the expense of creating, from several hundred to thousands of dollars per minute, and the time it takes to create that content, with the shooting, animating, editing steps and such. With modern-day technology, it is possible to generate content and to display that content in real-time, particularly live content.

A common technique in augmented or mixed reality is to extend, modify, substitute or superimpose parts of an image that normally appears on the device screen by the use of the device camera with another image uploaded or streamed to the device or generated on the device locally, so as to produce a combined real and artificial image that results in a mixed or augmented reality image.

Although such devices become more and more popular in commercial and industrial applications where a static image or a video are overlaid on top of the device camera image to provide placement of an object in a space, the placement and the behavior of the overlaid image are usually either fixed or can be determined by the user moving the image manually on the screen, or placed automatically as an overlay on the image by the AR application identifying a fixed pattern in the real image, also known as an anchor-image, and placing the overlaying image in a fixed location in relation to the detected anchor image. This limits the possibility of the AR image to interact with the natural environment captured by the device camera and requires placement of the anchoring pattern in the real environment.

### SUMMARY

This document presents systems, methods, and configurations in which digital electronic displays display content generated in real-time on hardware units running content engines that support interactive content, and in which the content generated is controlled and/or altered by a live input. In some implementations, a depth camera is installed within the vicinity of the display that would monitor nearby people, and uses that data as input to the content generator on the hardware unit in which the detected movement is used as input data for the dynamic content generated that would be a part of the interactive content displayed on the display method.

While not limited to the use of a depth camera, some implementations include one or more smart sensor or system that performs intelligent analysis from sensors to derive useful information from user signals. This has the added benefit of making the display interactive, whether audio-reactive, visual-reactive, touch-reactive, movement-reactive or the like. A display includes both audio and visual content that are rendered by the content engine. The responsiveness and interactivity features of the content makes a display more enticing and better at capturing the attention of those it is trying to engage.

To overcome limitations of static and entirely pre-rendered projected or displayed content, the disclosed method and system utilize signals obtained from viewer attributes, behavior and a local environment in order to adaptively alter and generate the content of the display and send the customized content to a mobile device or to the device of another user who is viewing the augmented reality event through a mobile device. This enables creation and deployment of interactive experiential environments, i.e. environments created for a specific experience, and enables augmentation of content within existing and new deployments of digital displays.

Implementations of the current subject matter can include, but are not limited to, methods consistent with the descriptions provided herein as well as articles that comprise a tangibly embodied machine-readable medium operable to cause one or more machines (e.g., computers, etc.) to result in operations implementing one or more of the described features. Similarly, computer systems are also described that may include one or more processors and one or more memories coupled to the one or more processors. A memory, which can include a non-transitory computer-readable or machine-readable storage medium, may include, encode, store, or the like one or more programs that cause one or more processors to perform one or more of the operations described herein. Computer implemented methods consistent with one or more implementations of the current subject matter can be implemented by one or more data processors residing in a single computing system or multiple computing systems. Such multiple computing systems can be connected and can exchange data and/or commands or other instructions or the like via one or more connections, including but not limited to a connection over a network (e.g. the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims. The claims that follow this disclosure are intended to define the scope of the protected subject matter.

### DESCRIPTION OF DRAWINGS

The accompanying drawings, which are incorporated in and constitute a part of this specification, show certain aspects of the subject matter disclosed herein and, together with the description, help explain some of the principles associated with the disclosed implementations. In the drawings,

FIGS. 1A and 1B illustrate a system having one or more features consistent with implementations of the current subject matter;

FIG. 2 shows an interactive content manager having features consistent with implementations of the current subject matter;

FIG. 3 illustrates methods and systems for automatic content generation;

FIG. 4 illustrates the logic imposed within interpretation and processing of input content;

FIG. 5 illustrates a system for generating a multiresolution representation of images, consistent with implementations of the current subject matter;

FIG. 6 illustrates a management module for managing the creation and distribution of content to displays over a network;

FIG. 7 shows a content engine that includes an analytics module;

FIG. 8 illustrates blending, combining and/or aligning artificial, dynamically updated virtual content with other content that is anchored and statically situated in the natural environment; and

FIG. 9 shows a collection of interactive contents, their collection of trigger conditions and associated trigger targets.

When practical, similar reference numbers denote similar structures, features, or elements.

### DETAILED DESCRIPTION

The present invention relates in general to the generation of interactive content by combining, blending, layering, mixing, generating or any combination thereof, of multiple digital contents, where the generated contents are controlled by interaction with viewers via live signals from sensors or by detecting and interacting with viewer mobile computing devices or any combination of user signals and additional information derived from signals to generate the control. In some implementations, a system and method incorporates analysis and management of the interactive content over a network of computers, such as the Internet, for the interactive content generated in real-time on a hardware unit with live signals as components of the content creation process, where the content is delivered to a display in an appropriate output method, based on a nature, i.e. format or context, of the content.

The analysis can pertain to both the duration of interactive content playback, the interactive content generated, as well as the analysis of other features detectable via the live signals. The display method includes multiple displays over a network, and the signals include multiple signals collected from multiple users. The live signals can be continuous or disrupted and can come from a range of input devices such as cameras, microphones, sensors, monitoring devices, and any combinations of stored and real-time data over time for purposes of alteration and creation of content, or any subset or segment of a pre-existing data or content, to be shared through its respective delivery method, whether that method be visual, textual, auditory, kinetic or any combination thereof.

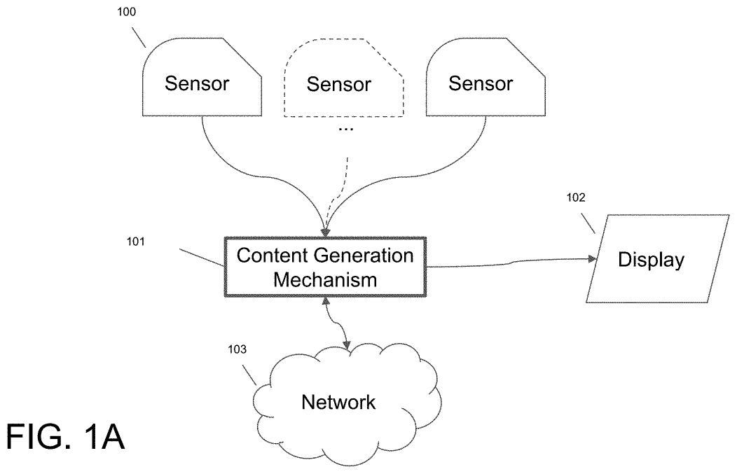

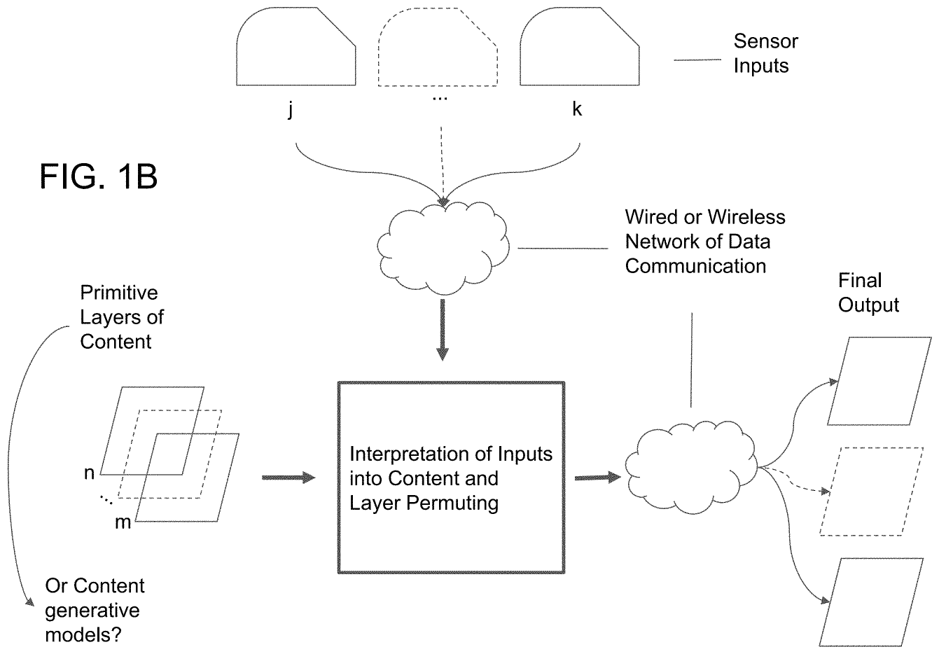

As shown in FIG. 1A and 1B, in the case of a prolonged lack of input data, historic or simulated data can be used as the input until a sufficient amount of new input is delivered by sensors 100 into a content generation mechanism 101, for rendering in display 102. The input data is either sent over a network 103, such as the Internet, for analysis, or abstractions of the data, are sent over the network for considerations in the management aspect of the content.

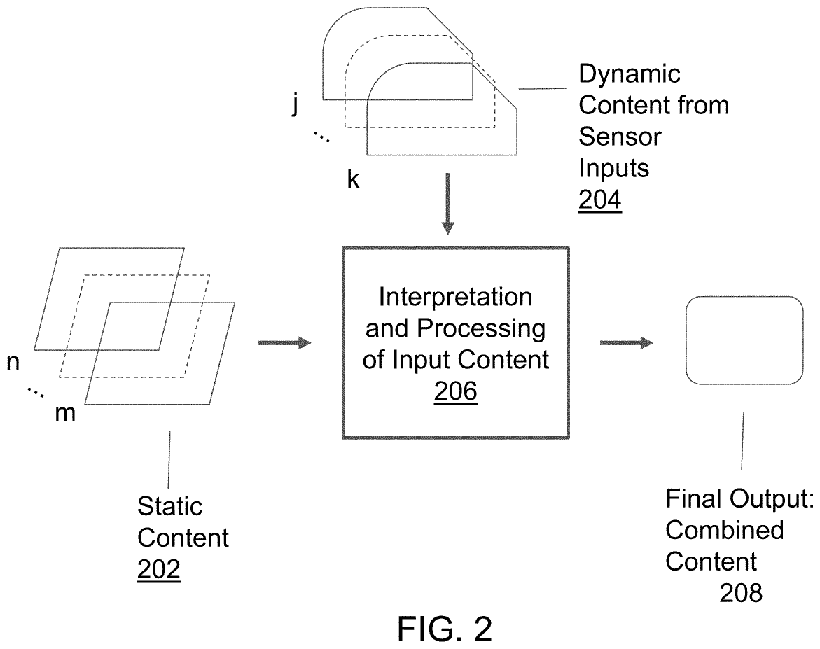

As shown in FIG. 2, the interactive content is managed as a combination of static pre-rendered content 202 and real-time generated dynamic content 204, which are interpreted and processed by content generation engine 206 for rendering in one or more displays 208. The static content 202 and dynamic content 204 includes or incorporates, but is not limited to images, videos, audios, computer-generated content, or content elements, modified by signals detected from the viewer in order to create a combination of static pre-rendered content and dynamic real-time content. The analytics recorded within the system may further pertain to features extracted from within the static and dynamic content of the interactive content, such as metadata or tags from the static and dynamic content. As at least some of the digital content is generated live from an input device, augmented reality content can be generated in real-time for integration with the digital content. In particular, the systems and methods described herein enable creation of augmented reality experiences without the need for users to be wearing assisting devices such as a virtual reality headset or specialized computer glass eyewear.

The augmented reality experience is created by real-time control and alternation of content on various digital display devices using signals collected in an environment about the user, that can be additionally combined with added content that can be viewed on a mobile device that is viewing the scene. In some implementations, one or more triggers can be added to the interactive content, in which when a condition is met, as it relates to the sensors in use, the system transitions to a different interactive content combination of static and dynamic content. There is no limit to the number of triggers that can be placed within the interactive content, no limit on the diversity of other interactive content that it then triggers, and no explicit requirements or relations between the static and dynamic content within the interactive content and the conditions for the triggers. Analytics recorded by the system may contain the sequence of triggers activated, which can be cross-validated with other analytics measured to localize down to each viewer interaction. Furthermore, the analytics detected can be used to meet trigger conditions that would change the state of the interactive content. The triggering can be based on, without limitation, a detected demographic attribute of the viewer(s) to personalize the content each viewer is viewing.

The creation of interactive content through the combination of dynamic with static content requires a careful alignment and combination of content from multiple content sources. The static content can be sourced from one or more of: a fixed image, a video, social media feed, computer graphics that are generated or displayed on a mixed reality device, or any other animation or visual content that is rendered on a display without interaction from the input signal reacting to the user. The static content can be accessed from a storage device, or streamed over the network or recorded live, generated by computer code, or any combination thereof. The dynamic content includes one or more of: images, videos or computer-generated imagery that are dynamically processed or altered in response to signals arriving live to the system through sensors, or other inputs.

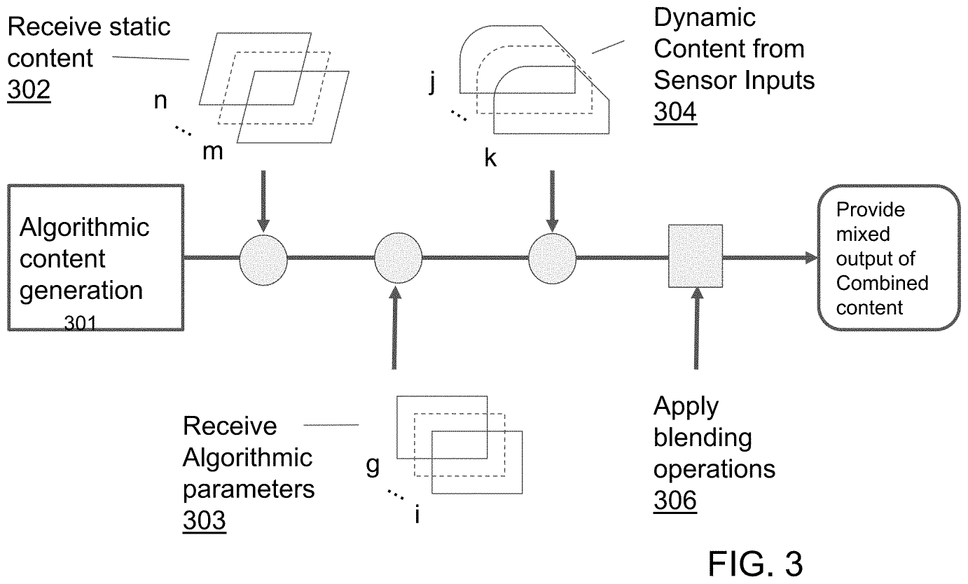

As shown in FIG. 3, methods and systems are described herein for automatic content generation 301 by overlaying, blending and altering static content 302 and dynamic content 304in ways that create an enhanced experience to the user, employing techniques of image and audio representation, processing, and alteration of static and dynamic content that meaningfully combine aspects of the dynamic and static audio-visual data sources into a combined interactive content.

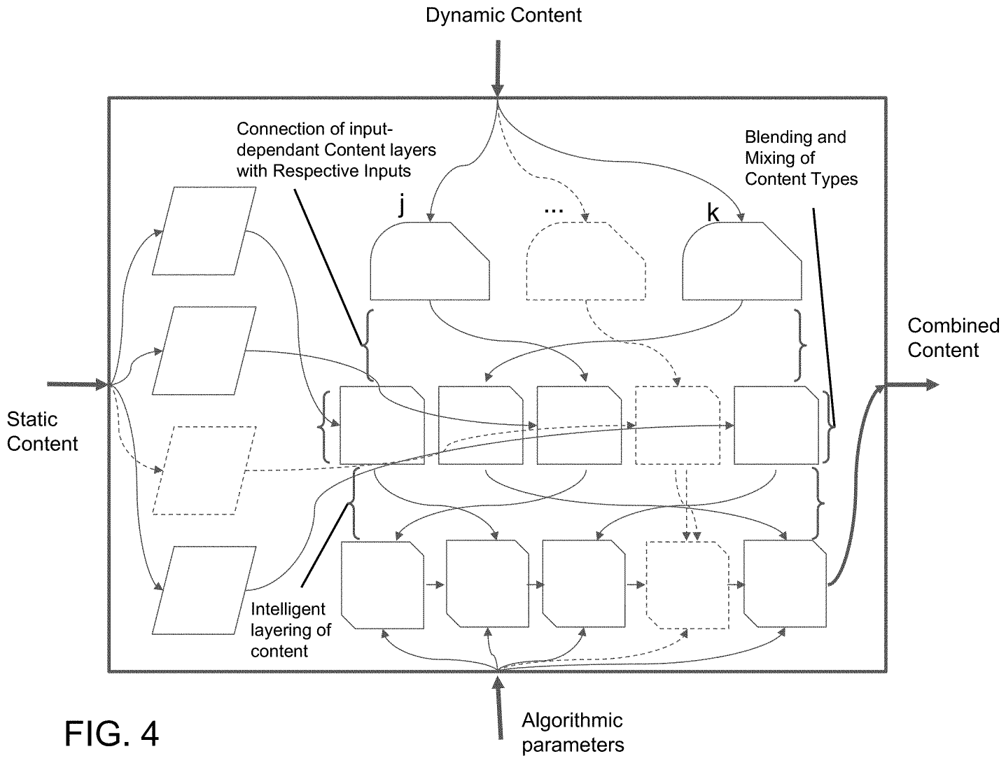

In some implementations, digital content is altered or generated by a system receiving algorithmic parameters 303 for processing of numerical values obtained from live signals, whether that signal is continuous or disrupted. Input from input devices such as sensors, cameras, microphones, and/or monitoring devices, is processed by blending operations 306 for being blended or mixed with stored and real-time data, or any subset or segment of pre-existing data or content, and delivered dynamically over time for purposes of alteration and creation of combined content through its respective delivery method, whether visual, textual, auditory, kinetic or any combination thereof, for delivered to one user or multiple users simultaneously. The resultant displayed digital content is designed to engage viewers with an evolving message, and therefore a sequence of different interactive contents may be desired when engaging viewers for an extended period of time, as depicted in FIG. 4.

FIG. 4 illustrates the logic imposed within the Interpretation and Processing of Input Content in which the dynamic content and the static content are intelligently permuted and matched in the Connection of Input-dependent Content Layers with Respective Inputs section, which are then intelligently blended and mixed before entering the layering phase in the Intelligent Layering of Content section before being combined to create the final combined output.

To properly iterate through different interactive contents appropriate for the viewer, triggers are provided that enable the interactive content to automatically change to a different interactive content based on specific triggering conditions. Example trigger conditions that activate the transition to different interactive content include designated gestures or other actions of a viewer, or may include a length of time a viewer interacts with the interactive experience, or a detected demographic attribute or perceived identity of the viewer, among other possible conditions. These enable the viewer to engage with the designed digital content to a greater degree, in which the interactive content can be automatically personalized to the viewer, or the viewer may select the interactive content they engage with by activating different triggers, such as by physically hovering over different displayed features or interactive controls within the interactive experience, performing a specific gesture, posture or movement that is recognized by the system, or a combination thereof. Any combination of triggers, trigger types and interactive content may be defined, configured and used, thus giving a designer a great amount of freedom and flexibility when designing the viewer experience.

With the type of content displayed advanced to such a level that it is generated in real-time and triggered by the viewer, managing that content still needs to be considered. While having autonomous digital displays to display uniquely curated digital content from multiple sources (both static and dynamic) is one goal, in which the content is automatically updated and targeted towards a particular viewing audience, a content management system is configured to load and manage the content that will be displayed. The content management system is configured to communicate with hardware units that control the content displayed via a network, such as the Internet or Virtual Private Network (VPN), or the like.

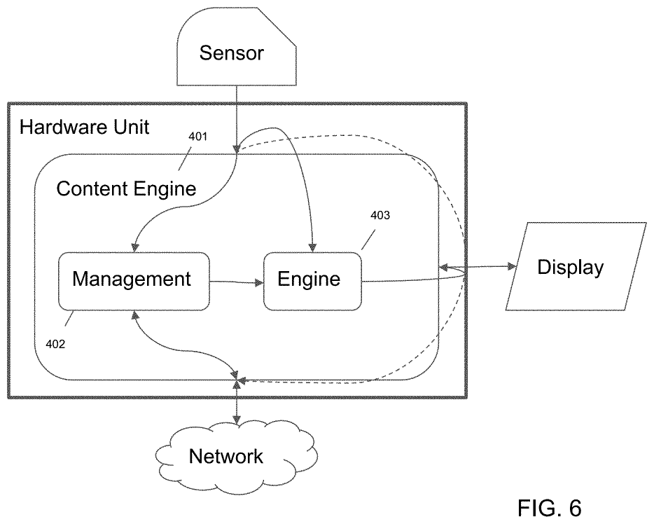

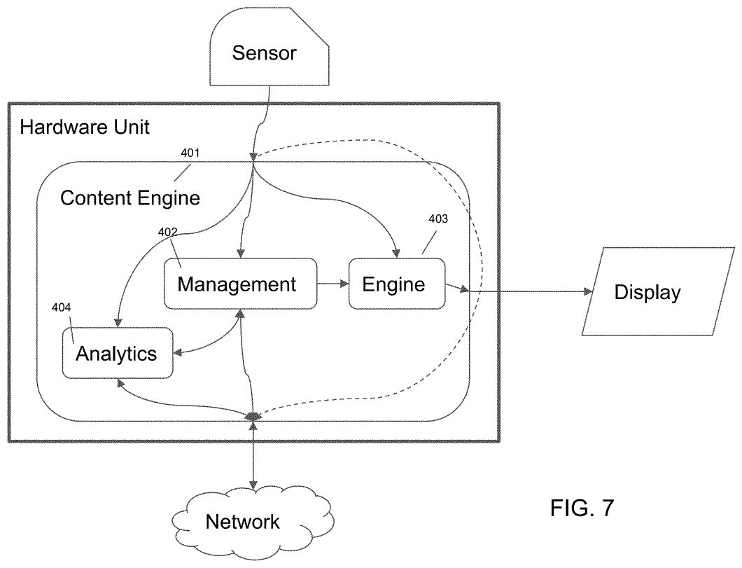

As shown in FIG. 6, a management module 402 manages the displays, referred also hereafter as updating the content, can include everything from altering an aspect of the interactive content to changing to different interactive content to controlling the rate of change between different interactive content types. For example, remote network/web-based control for updating the content can include adjustments of dynamics that a content-generating engine 403 uses within the hardware unit that is connected to the display. As a part of updating the interactive content, uploading of data to a content engine 401 for incorporation into the generated content can be done over the network. As shown in FIG. 7, the content engine can also include an analytics module 404, as described herein, for executing analytics on the content.

One such implementation includes uploading an image over the network to be integrated into the content engine, where the integration includes techniques ranging from simply layering the image above or below the generated interactive content, to incorporating elements from the image into the dynamics of the created interactive content, to using elements and extracted features from the uploaded image to adjust the parameters of the interactive content without directly integrating the image into the displayed content. This web-based control essentially allows a remote machine to adjust, modify, upload and monitor the content creation engine on the hardware unit through a communication channel over the network.

As the number of digital displays keeps growing, managing them becomes more cumbersome, but it is desired to have them as autonomous as possible. Creating intelligent autonomous displays requires having data driving the behavior of the displays. Accordingly, one or more sensors can be used input for the content engine, and the data from the sensors can be used to drive the behavior of the displays. The data from the sensors can be analyzed either on the hardware unit directly or via the network, or a mixture thereof, and one or more analytics algorithms performed to extract analytics. These analytics can be integrated with other available information and be used to intelligently manage the content of the digital display through the network.

In some preferred exemplary implementations, a camera is used as the sensor to capture one or more images of a viewer, with analytics extracted from the data stream provided by the camera, and from which a neural network approximates an age of the viewer as they interact with the system. In one example, the system can then target viewers classified as younger individuals and trigger a kid-focused message such as “Come and play around,” whereas for viewers classified as older individuals the system can trigger a more mature message such as “Come and interact.” Further, other data such as time of day can be used to dominate the color of the generated content, such as coloring it yellow in the morning and blending it into blue around evening time. This is a very specific example, and the analytics can range to anything extractable from the input type to the sensor used, and the additional integrated information can come from any source available to the network.

The analytics derived from the input sensors combined with other data enables the system to behave intelligently and alter, monitor and manage the content engine to optimize the displayed content and optimize multiple display systems intelligently configuring the content of the multiple systems with respect to one another by communication over the network. By aggregating and storing the input data stream analytics and the interactive content analytics, such as triggers activated by viewers and a sequence of activations thereof, a rich amount of analytics data can be collected and used for data-driven decisions by the human management and design team to continually iterate on interactive content and to measure the impact the iterative changes. This can become particularly worthwhile depending on the domain, such as the advertising domain utilizing the invention described here to remotely deploy interactive content and measure engagement and impression count of their interactive content.

Multiple Image Manipulation and Combination with Live Augmentation

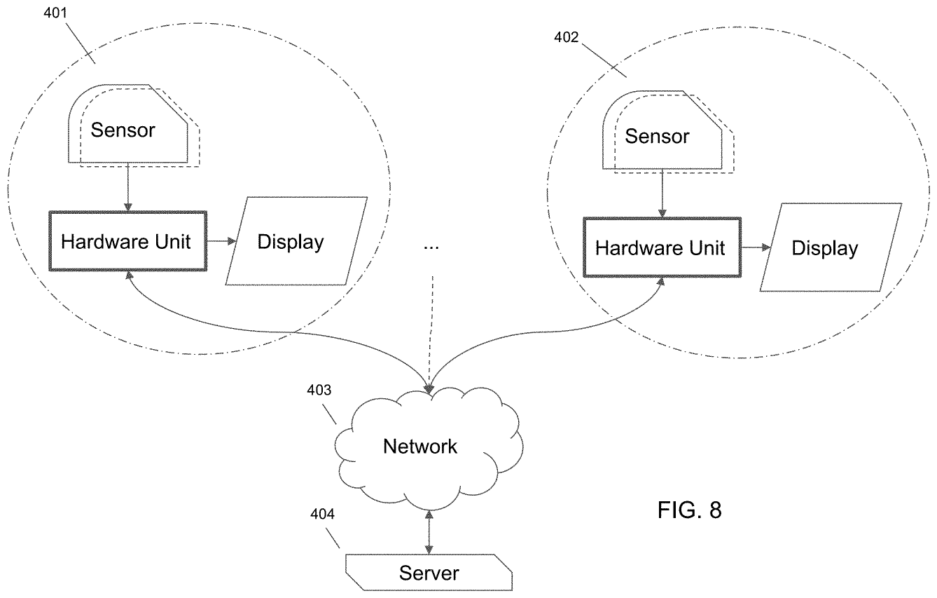

As shown in FIG. 8, a system creates an enhanced user experience by blending, combining and/or aligning artificial, dynamically updated virtual content with other content that is anchored and statically situated in the natural environment. To achieve such blending, combining and/or aligning, meaningful relations need to be established between different elements respective content. In a simple example, the static content could be an image from a natural environment or a graphic such as text or a logo in a commercial advertisement, and the dynamic contents can be special graphic effects, such as smoke or fire, or graphical objects that act in response to natural actions of the user. In order to combine the multiple contents, the objects in the static images have to be identified, such as using computer vision techniques, and analyzed to determine pixels and areas in the static image corresponding to regions or elements of interest, such as contours of letters in a logo or edges, segments and layout of the objects present in static images and so on. The system then establishes rules that alter the behavior of the graphical elements in the dynamic image so that they take into account elements, objects, or regions in the static image so as to simulate a physical interaction between the dynamic and the static contents. Such interaction is not possible by simple alpha blending and layering between the different contents, and requires the establishment of masking or geometric vector regions with specifications of altering the behavior of the dynamic content. In many cases finding the regions and imposing masking or other grids or regions of interaction between the contents of the static image and the dynamic content is difficult, imprecise and time-consuming if manual analysis and marking are required. With the wide range of static pre-rendered content possibilities, such as a videos, 3-dimensional objects, animated objects or live captured feeds from other software running on the hardware device, a manual analysis, performed only by a human, is not feasible.

While existing technologies are able to detect and overlay grids or meshes over specific images such as common overlay masks on human faces or adding virtual creatures on an image from a camera shooting a natural scene, such technologies require high precision and special interactivity to effectively blend the static or natural content with the dynamic virtual contents, and are often hard to produce for general images or in natural environments such as for out-of-home advertisement situations. The presently disclosed implementations allow for decomposing images and assets into different layers that capture hidden structures in the image, and separating the contents of the image, such as the structure of main objects or other semantical attributes, from the foreground, texture or style aspects. Accordingly, the present system is configured to blend dynamic contents with the different semantic or style aspects of the image by creating relations between respective semantic or style layers in the dynamic and static images, specifying transformations or filtering operations on these layers, and combining them in order to produce a final mixed image.

Image Representation Methods

According to some implementations, an image is subject to repeated filtering and subsampling operations that create a multi-scale image layers representation. Examples of such representation are a pyramid representation, a scale-space representation, and multiresolution analysis. The filters, often known as kernels for a convolution operation, and the weights of combining the layers into the final image, can be fixed, or pre-calculated in ways that are optimal for specific types of images or image processing tasks, or can be adaptively learned by the computer from examples. In another implementation, a digital image may be processed by an ensemble of convolutional neural networks (CNNs) to create a layered representation, where each layer contains the result of a filtering or classification operation.

In some cases, a combination of several image layered representations can be used to combine the multitude of images into a new image result that has some common properties of the original images. Examples of such combinations include, but are not limited to, texture overlaying and modification via shader operations, style transfer and image morphing, including geometrical transformation on images learned from a set of images with different orientations.

In a simple example, one of the contents can be images that represent a static image and the dynamic content is a computer-generated image of an object or collection of objects manipulated by the movement of a user that is overlaid on top of the static image. A mask, a grid, a mesh or any other coarse of fine or multi-resolution representation of locations in the first image is used to determine regions, edges or points according to which the elements of the dynamic content may move, appear, disappear or change their movement or appearance. The resulting mixed image creates an impression where elements of dynamic content meaningfully interact with objects of static content.

In another example, filtering or various image transformations, such as local affine transformations, blurring, color changes or any other image operation may be applied to static content before mixing with dynamic content according to said regions or grid. Such transformations may create an appearance of interaction between static image and elements of dynamic content, such as distorting regions or geometrically changing the appearance of regions in the dynamic content. These transformations may be also applied without the dynamic content elements being visible, such as allowing a user to modify the static image by moving or controlling invisible objects in the dynamic image.

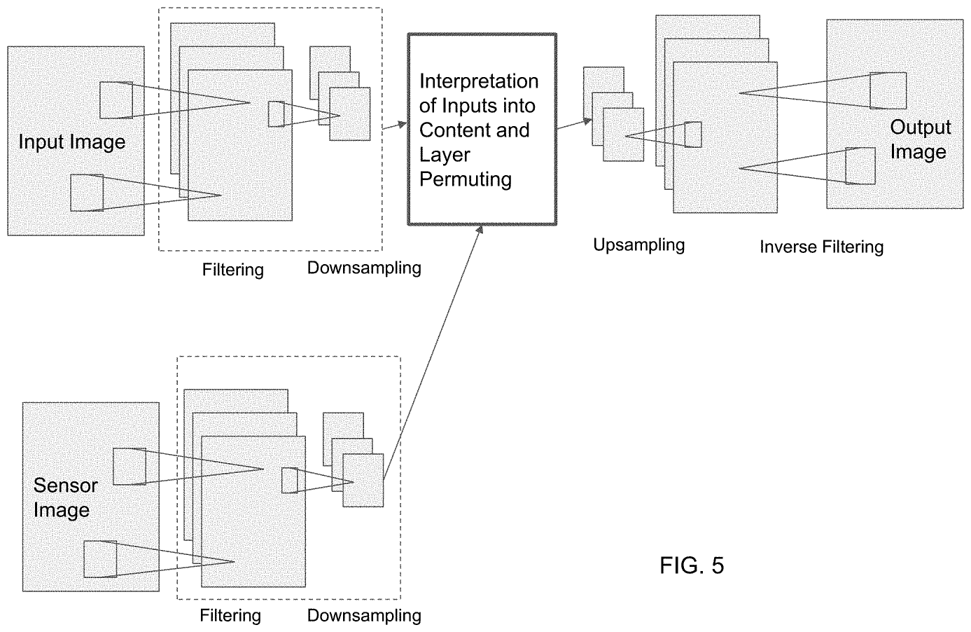

The system generates a layered operation on a combination of images of a fixed structured image or video and an input data stream derived from a sensor such as a camera or a combination with a depth sensor such as 3D camera. The operation between the image layers can include, but is not limited, operations such as masking or alpha blending, or any linear or nonlinear function mapping between pixels of the two images that result in an output pixel. This implementation can be generalized to a multiresolution representation of images, as illustrated in FIG. 5. In such cases, the operation between sensor derived input data and static content is subject to a sequence of filtering and downsampling operations, and the transformation and permuting operations occur on one of the deeper layers. This can be further generalized to a larger number of images in a multi-image content combination scheme.

Dynamic Mixed Reality Image Blending on a Mobile Device

The system and methods described herein allow for dynamic control of an AR image from user movements, or adapting it to a general environment without the physical placement of anchor-images in the physical environments or designating fixed objects in a natural image as an anchor. Accordingly, a mobile device camera image is dynamically processed to identify a broad range of semantic attributes in the image and to alter the virtual image so as to optimally fit the environment captured in the image. The system and method uses semantic image analysis, such as extracting information from inner layers of multi-layer image representation such as convolutional networks, in order to determine the position and other geometric transformations for blending of images in an AR application. While some systems exist that can analyze specific types of objects, such as faces or hands in order to detect important object features and possibly overlay a synthetic image, often using a mesh approximation of the object structure, the present system and method can overlay AR content on a natural environment in response to user movement or other signals extracted from the environment in meaningful ways.

In some implementations, AR content placement on the mobile device is combined with an image generated using previously described layering methods rendered on another display, such as in the case of a user viewing on a mobile device another display or a projected image. Using an image layering technique previously described, a pattern of synthetic markers are added to the resulting image as an anchoring-layer for AR application. As examples, the encoding of the anchoring-layer can be presented as dot patterns or color coding, or for generation of synthetic realistic images that the AR application recognizes as anchors.

These anchor-layer patterns are dynamically modified based on signals from sensors such as camera, motion capture devices, sound or any other signal that the system uses to modify the presented image by layering the anchoring patterns on the display or projection system. As a special case of an anchoring pattern, specific instruction about modifying the AR image behavior, such as triggering autonomous behavior of the AR image either as a sequence of predetermined movements and transformations or as dynamic instructions generated by computer code, can be transmitted or sent to, and received by, the AR application. This allows lowering the anchor update rate for highly dynamic sequences or introducing pre-programmed dynamic behaviors into the system.

Rapid Composition

A multi-layer approach to interactive visual media design is accomplished by specifying a network arrangement of multiple assets that are related by links with a set of additional information, comprising of spatial and temporal rules and logic for the combination of these assets. Accordingly, the network of assets with the rules of their compositions serves for quick authoring and fast delivery and presentation of multimedia applications represented in an edit specification comprising: a) a collection of linked assets, b) one or more file servers connected to the network, at least one of said file servers containing multimedia assets, c) at least one algorithmic encoding of graphical generative or processing operations, and d) at least one user location containing terminal connected to the network. An authoring UI provides textual or graphical edit operations that specify logic to activate retrieval of objects, data or code stored on the one or more file servers, including functions to add static content to be stored or referenced by the objects, and activation of graphical generators with mechanisms for initiating playback of the objects retrieved in a sequence corresponding to that represented by the specified logic. The specification of the link layering and activation can be expressed by temporal logic methods, such as token passing mechanisms of petri nets or other formal methods for sequential and concurrent asset management. The multi-layered description with multi-instance support for different types of multimedia assets allows for flexible and fast prototyping of presentations with interactive temporal and spatial rules of asset compositing.

Interactive mixed media events comprised of static and dynamic assets (photo, graphics, music, text and so on) are identified in the encoding through a unique ID in a data structure. Static assets can include pre-rendered content, while dynamic content can include real-time generated content. After listing, and potentially sorting and/or marking media events in the data structure, they can be described in different layers (e.g., the graphical aspect of a texture and its dynamic rendering parameters), and multiple times within a single layer (e.g., the primitives of that texture in different interactive performances or its dynamics in different scenarios). Consequently, the multi-layer environment described herein supports two synchronization modes:

1. Inter-layer synchronization, which takes place among contents described in different layers. Different layers are used to store heterogeneous information referring to the same interactive media design in a synchronized way;

2. Intra-layer synchronization, which occurs among the contents of a single layer, where homogeneous information is contained.

Coupling the aforementioned kinds of synchronization, it is possible to design and implement an advanced framework for mixed media and augmented reality scenarios, whose goals could range from an advanced media experience to graphics-based edutainment, from cultural heritage to movement and dance practice and education, as just some examples.

Association of Specific Key Points and Processed Data into the Controls of Assets

In creating engaging dynamic content within the interactive content, creating scenarios in which a post-processed representation of the input data is then used by the dynamic content can lead to more nuanced interactions. By creating methodologies that process the input data, it is possible to feed different key points or post-processed data into the controls of a range of multimedia assets. A simple embodiment is the processing of joint position and movement from a camera input data stream and using those key points to control a dynamic content of an animated character moving in those same movement sequence or complementing movement sequences. Controlling the character can be done by controlling the rendering size, orientation and position of a sequence of Portable Network Graphics (PNG) image assets each representing different segments of the body or by using a more sophisticated multimedia asset such as Filmbox® (FBX) such that each key point movement is mapped to a movement of the FBX object's key points. Again an exemplary implementation is an FBX model of a humanoid figure where the viewer's movements are mapped to the humanoid figure's movements. While many different content assets and formats are available and possible, by utilizing a processed input data stream upon them it is possible to create sophisticated interactions within the dynamic content.

Triggering

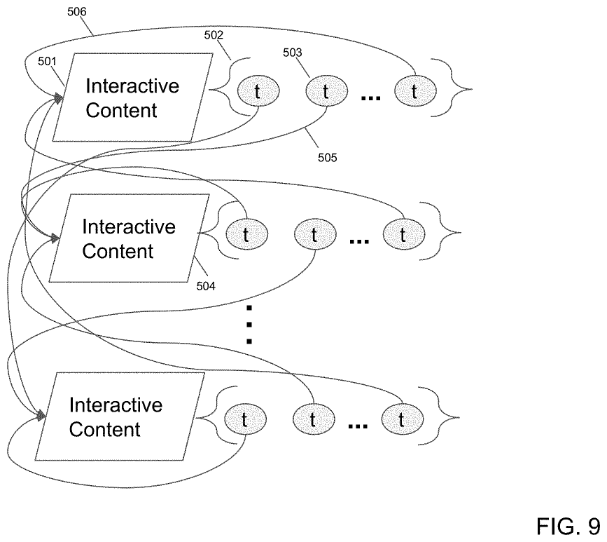

FIG. 9 shows a collection of interactive contents, their collection of trigger conditions and associated trigger targets. 501 shows an interactive content in which 502 is the set of trigger conditions associated or contained with 501 interactive content. 503 is a specific trigger condition within the 502 set, and 505 and 506 show the paths from trigger conditions to the target interactive contents once their respective trigger conditions are met. 504 is a separate interactive content from interactive content 501 and 505 is a trigger path from trigger condition 503 that would transition from interactive content 501 to interactive content 504. 506 shows a trigger path from interactive content 501 to itself. When an interactive content triggers itself it can reset media elements within itself, such as restarting a video asset within the interactive content, or can trigger specific media assets within it. There can be any number of interactive contents, any number of trigger conditions within a set of trigger for an interactive content, and any potential paths for a trigger condition to an interactive content including cases where the origin and destination are the same interactive content.

In the creation of interactive content to engage and stimulate viewers, different interactive content may be ideal based on environmental factors, viewer factors, and viewer behavior. This rich context around the interactive content leads to the need for sophisticated condition-based transitions between interactive contents that lead to the intelligent triggering of the appropriate or ideal content for the viewers or context. The state of the conditions for triggers are limited to conditions that can be tracked and fulfilled by the input data stream received by the system, as well as corollary data the system may access or may receive through other components of the system or base hardware it is running on as well as data received via the Web, for instance. The trigger targets, as each relates to the interactive content the trigger will cause the system to transition to, can change freely from moment to moment, and the trigger conditions, the number of triggers and the trigger targets are largely expected to change as the state of the interactive content changes, such as would be the case if a trigger is activated.

A simple example of triggers in a low-complexity interactive content scenario of two states, henceforth referenced as interactive content A and interactive content B, can be a trigger altering the content if a viewer is present or not present with a system that has a camera connected as the input data. Such an example scenario would entail interactive content having a trigger condition that if a human is identified in the input data for two seconds, then transition to interactive content B, and vice-versa with interactive content B having a trigger condition that if no human is identified in the input data for two seconds then transition to interactive content A. Such an implementation does not require that interactive content A or B have dynamic content within them, but still enables the system to engage the viewers in a deeper and more intelligent way. For example, such an implementation could be used at a hotel lobby in which interactive content A is a generic colorful video and interactive content B is a welcome message followed by a video of the hotel's facilities, thus the system would create generic ambiance when no direct viewer is present (i.e. within a predetermined range) and would offer informational material when a viewer is detected in front of it within the predetermined range.

Any number and sophistication of triggers are possible, and potentially required, when engaging viewers for a longer time period. The state of the dynamic content within the interactive content can be used within the triggers' conditions. When considering interactive contents A, B, C and D, for example, the system could at present be on A with three triggers that lead to B, C, and D, respectively. The conditions for these triggers can be defined across a grid of the display's size in which a unique quadrant is defined for each trigger as the area dynamic content (such as the silhouette of the viewer) must be present for two seconds (where the number two is arbitrary) and where, at the same time, the quadrants that serve as triggers for the other interactive contents must not be present with dynamic content. This would effectively enable a viewer at A to transition to B, C, or D at will by moving in space, thus altering the dynamic content he or she generates. Furthermore, to overcome uncertainties in which the viewer is activating multiple quadrants that are associated with different triggers, or deal with transition phases that temporarily activate multiple triggers, a temporal logic is used to incorporate into the triggers not-conditions that require that there be regions and times where no signal or dynamic content is present or generated. Lastly, the dynamic content elements or attributes that fulfill the conditions are arbitrary and can be any implementable scenario. By making several layers of interactive contents with numerous triggers, one can design a rich sequence of interactive contents that the viewer can traverse with freedom giving the viewer a sense of agency in deciding and dictating the content they observe and interact with.

Intelligent triggers are possible by combining and incorporating analytics and features gathered via the input data stream as a part of the conditions. For example, the trigger conditions can be one or more demographic attributes of the viewer present. For instance, if the system recognizes the viewer as a young male, it could trigger interactive content alpha and when the system recognizes the viewer as an elderly female it would trigger interactive content beta to allow for more personalized content to each viewer instance. A further sophistication is possible by adding temporal data into the analytics and conditions. An example of such would be interactive contents A, B, C, and D, and analytics tracking which viewers interacted with which interactive contents. As a viewer leaves a predetermined area monitored by the input data stream, after interacting with interactive contents A and C, and later returns to the area captured by the input data stream, the system can then trigger interactive contents B or D (or both) that the viewer has not interacted with prior, after recognizing the viewer. The analytic recognition mechanism can be implemented through a wide range of technologies, one of which being recognizing facial features of the viewer through a camera input data stream.

Triggering conditions can further be expanded to include query conditions in which the triggering target is non-deterministic until a query condition is fulfilled. Returning to the demographic example, in which the viewer's demographic is the trigger query, the system would then dynamically query existing resources and available assets from its database to dynamically adapt the interactive content to content that is best suited for that viewer. Alternatively, for a person recognition analytic as the query the trigger could invoke a query of the detected person to incorporate the person's name into the dynamic content, where the name may be accessible from a dataset of face-to-name associations or default to other values if the face is not found in the dataset. Alternatively, the query may be a beacon from the viewer's mobile computing device such that the trigger activates interactive content specific to the recognized viewer based on the detected mobile computing device they carry. These sort of trigger conditions as a query enable the system to further personalize the interactive to the viewer in a broad sense but even to personalize to the viewer as an individual if desired.

Due to greater environmental contexts being a strong attribute to the appropriate content to display to viewers, external data accessible via the base hardware unit and via the Web can be used within the trigger conditions and trigger queries. Such data includes, without limitation, time of day, weather conditions, social media activity, data streams such as the Dow or S&P 500, news outlets, and the like. An example is the time of day triggering interactive contents associative to the morning, afternoon or evening depending on the time of day. Alternatively, a trigger query based on the weather can alter the interactive content's background layer with assets indicative of the current or forecasted weather. Furthermore, a data stream, such as data from the S&P 500, can be used within the algorithmic parameters of the generative content within dynamic content such that the dynamic content reacts to external contexts, among many other possibilities.

Communicative triggers are further possible by incorporating processing to the input data stream such that more semantically rich features are extracted from the trigger's conditions. Gesture tracking and recognition processing can be used on the input data stream using sequence encoders that then associate with triggers. The sequence encoder can receive the input signal and generate a query or hashtag in a database that is associated with the interactive content to dynamically select or change the state of the interactive content. The sequence encoder may be implemented through a variety of methods such as template sequence matching with dynamic time warping, hidden Markov models, recurrent neural networks, or others. This can enable triggers that semantically understand the viewers, such as recognizing general body gestures such as pointing or nuanced gestures such as changing facial expressions, and trigger interactive content appropriate per the detected gesture or detected state of the viewer.

As explained above, sophisticated condition methodologies for triggers are possible but simple conditions are also possible, a basic example of which is a simple time-lapse condition for a trigger such that the interactive content transitions to a different interactive content after a preset amount of time lapses for the current interactive content. This would effectively enable a playlist-like mechanism that transitions from interactive content to interactive content over time. Another simple condition is the trigger condition being fulfilled by a control agent either with direct access to the system or access via a network. This could be a human controller that clicks to change the interactive content state or sends the message via the web, or another system such as a Content Management System that could send a message to trigger a change in the state of the system's interactive content.

Deep Learning Transformations on Content Layers and Transitions

In creating rich interactive contents that engage viewers, deep learning methodologies can be used to create deeper connections between static content and dynamic content based on viewer behavior and environmental conditions. An example of such is a style transfer methodology in which the style of a static content can be applied to the dynamic content. Such applications can originate from evaluating a style of the static content live or by using pretrained models as the static content, thereby expanding the notion of static content to further incorporate trained models and expanding intra-layer synchronization. Such techniques can further be applied to the transition states between interactive contents.

When transitioning between interactive contents, there are a range of possibilities. Some possible traditional transitions include a simple crossfade, a fade to black, a fade to a transition image/video, an application of a transition filter like those known in video editing etc. Due to the nature of the system, having access to the current interactive content state and the target interactive content state after the transition, a more sophisticated method is possible that utilizes both states to create a smooth transition across the two states or transforms the current state to the target state. An example of such can be implemented using deep learning methodologies that determine and intelligently transform the last image state of interactive content at the current state t into the first image state of interactive content for the target state t+1. By creating more sophisticated transitions between the interactive contents, a more engaging output can be created to retain the viewer for longer periods of time.

Analytics Application

An important property of interactive communication devices is the ability to provide information about user behavior in terms of broad attributions, such as duration and extent of engagement with the interactive content, user emotional state and other contextual information that could lead to follow up actions with the respective user, if the user is identified, or changing of the communication strategy in the interactive content to adopt to broad class of user demographics or to environmental or situational information. In the age of out-of-home interactive devices, such as digital signage devices equipped with sensors, IoT sensor networks, WiFi and Bluetooth beacons and other tracking devices, the information about users might be available in a variety of raw formats that need to be further analyzed to discern more specific attributes that are relevant to the goals for the specific deployment of interactive content. In the disclosed system and method, the analytical component can be used to store data that can be used to extract semantic information about the viewers and for evaluation of broad classes of user emotional states from movement depending on the nature of the stored data. It has been shown in literature of dynamic modeling of signals, such as vocal expressions or natural sounds, that statistics of repetitions and regularity of signal patterns is indicative of emotional or affective states of the people producing or labeling such sounds. Further facial analysis methods are possible to extract the emotional state portrayed by the user via their facial expressions. It is also possible to extract the emotional state of users through capture and analysis of their gestures and movements.

An emotional state of users is only one example of possible analytics that can be collected by the system depending on the nature of the input data available. For instance, a heart rate of users can be tracked and analyzed by using sophisticated machine vision techniques that can evaluate the micro changes in skin tone from blood pumping through the viewers' blood vessels visible on their face. The outcome of the collected analytics can be transmitted together with time step, location, and other contextually relevant information to aggregate the statistics of natural user interaction with the deployment at large and with each interactive content state specifically. By collecting macro level analytics on the installation's performance and engagement at large, and micro level analytics on the engagement on each interactive content and each interactive content state, the system can be used to manage, alter, improve, and report on the performance of content generated and displayed by one or multiple installations and one or multiple interactive contents specifically. The location of the stored analytics can be local to the hardware or distributed to a network, yet furthermore the hardware on which the computational analytic processing is done is not limited and can be done on the same hardware on which the system runs or on different hardware available via the network. The analytics recorded by the system can be sub-analytics and metadata that can be processed at a later time or on a different machine depending on the implementation intention and scenario.

Distributed Management and Authoring

In deploying and managing the installation of interactive content, limiting the management and authoring to physical access to the systems' hardware is difficult and limiting. Accordingly, systems described herein can utilize the deployment of distributed computing and management where interactive content base requirements are broadcasted via a network to the installations. The interactive content base requirements enable the authoring process to be completed on hardware other than the hardware of the installation itself in which only the basic static content and dynamic content parameters, required for a different system to create similar instances of the interactive content (but perhaps not the exact same instances as the dynamic content will vary depending on the input data it receives), can be sent over a network. A trigger can further be activated for the system to load new interactive contents transmitted over a network. Furthermore, a system can receive interactive contents' base requirements over the network such that the system can effectively subscribe to channels of interactive contents created and broadcasted by different creators and sources.

One or more aspects or features of the subject matter described herein can be realized in digital electronic circuitry, integrated circuitry, specially designed application specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to programs, software, software applications, applications, components, or code, include machine instructions for a programmable processor, and can be implemented in a high-level procedural language, an object-oriented programming language, a functional programming language, a logical programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including, but not limited to, acoustic, speech, or tactile input. Other possible input devices include, but are not limited to, touch screens or other touch-sensitive devices such as single or multi-point resistive or capacitive trackpads, voice recognition hardware and software, optical scanners, optical pointers, digital image capture devices and associated interpretation software, and the like.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” Use of the term “based on,” above and in the claims is intended to mean, “based at least in part on,” such that an unrecited feature or element is also permissible.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claims.

What is claimed is:

1. A computer-implemented method for generating an interactive and augmented display, the method comprising:
receiving one or more static content objects comprising one or more of an image, text, an audio file, and a kinetic representation;
receiving one or more dynamic content objects comprising digital representations of actions received by one or more sensors;
blending the one or more static content objects with the one or more dynamic content objects according to a predetermined semantic or style relationship to generate one or more blended content objects;
applying transformations or filtering to the one or more blended objects to produce one or more final video objects, each comprising image data and one or more of audio data, kinetic data, and text data; and
transmitting the one or more final video objects to one or more displays over a network.

2. The computer-implemented method in accordance with claim 1, further comprising playing the one or more final video objects on the one or more displays.

3. The computer-implemented method in accordance with claim 2, further comprising modifying the playing of the one or final video objects based on one or more triggers sensed by at least one of the one or more displays.

4. The computer-implemented method in accordance with claim 1, wherein the transformations or filtering is further based on a demographic attributes of at least one viewer of the one or more final video objects.

5. A system for generating content for distribution over a network, the system comprising:
a collection of linked multimedia assets;
one or more file servers connected to the network, at least one of the file servers being connected with the collection of linked multimedia assets;
at least one algorithmic encoding of graphical generative or processing operations executed by at least one of the file servers for generating display content; and
at least one user location containing terminal connected to the network for displaying the display content.
